(19) United States
(12) Patent Application Publication
(10) Pub. No.: US 2026/0175380 A1
(43) Pub. Date: Jun. 25, 2026

(54) Adjustable Torque Wrench Improvement

(71) Applicants: Solomon Chang, Taipei City (TW); Fang-Yu Wang, New Taipei City (TW)

(72) Inventor: Solomon Chang, Taipei City (TW)

(21) Appl. No.: 18/991,767

(22) Filed: Dec. 23, 2024

(51) Int. Cl. B25B 23/142

(52) U.S. Cl. CPC B25B 23/1427

(57) ABSTRACT

The adjustable torque wrench improvement of the present invention, mainly uses the ball screw, the ball nut, the balls and other components in the adjustment structure to replace the traditional torque wrench's adjustment structure of screw and nut, and takes advantage of the ball screw's characteristics: high positioning accuracy, high durability, and high-speed reversible transmission transformation displacement, thereby reducing the friction of the torque wrench's rotation, achieving labor-saving and precise and quick adjustment of the torque wrench.

### FIELD OF INVENTION

The present invention relates to an adjustable torque wrench improvement, and in particular to an adjustment device implemented in an adjustable torque wrench using a ball screw. By utilizing the characteristics of the ball screw, the torque wrench will be more labor-saving, efficient and durable when rotating to adjust the torque, thereby replacing the conventional torque wrench's adjustment structure of screws and nuts.

### DESCRIPTION OF RELATED ARTS

The adjustable torque wrench is a precision tool that is mainly used to apply a certain torque specification when tightening screws (bolts, nuts) in order to avoid over-tightening or over-loosing. Therefore, in order to meet the needs of different torque adjustments, there are many adjustable torque wrenches on the market, which are generally divided into mechanical and electronic types. The present invention only improves the adjustable torque wrench of the mechanical type.

For the conventional mechanical adjustable torque wrench, refer to the relevant previous cases: Taiwan Utility Model Patent No.: M434652 (Screw 12), Taiwan Invention Certificate No.: I714469 (Adjustment element 50), Taiwan Utility Model Patent No.: M434652 (Adjusting Screw 30), Taiwan Utility Model Patent No.: M549139 (Screw 50), Taiwan Utility Model Patent No.: M556654 (Adjusting Screw 3), U.S. Invention Patent No.: U.S. Pat. No. 5,662,012 A (screw part B), U.S. Invention Patent No.: U.S. Pat. No. 8,863,624 B2 (adjustment screw member 31) . . . etc., the adjustment structure of the torque wrench disclosed therein is implemented by screws and nuts, which are used to adjust the required torque of the wrench.

However, the above-mentioned previous cases and the adjustable torque wrenches currently on the market all use screw structures for torque adjustment, as shown in FIG. 1, the screw structure converts rotational kinetic energy into radial linear displacement action to adjust the torque that the wrench can withstand. The disadvantages of this method are: large friction and low efficiency. When the range of wrench torque values is large, the user may need to make more laborious and time-consuming adjustments.

### SUMMARY OF THE PRESENT INVENTION

In view of the above-mentioned shortcomings, the inventor has delved deeply into research and innovation, integrating actual usage requirements, and developed an adjustable torque wrench improvement, mainly by utilizing the advantages of the ball screw to improve the shortcomings of the conventional screw structure.

Ball screw is a common mechanical transmission component, widely used in a variety of mechanical equipment, mainly used to convert rotational motion into linear motion, or linear motion into rotational motion. The ball screw has the characteristics of high positioning accuracy, high durability, and high-speed bidirectional transmission conversion displacement, but has not been implemented in adjustable torque wrench.

The ball device includes a ball screw, a plurality of balls, and a ball nut arranged thereon respectively. The ball screw is a cylinder and has a spiral channel surrounding on the surface thereof for the displacement of the rotating movement. The ball nut is a matching part with the ball screw. The ball nut has a ball track arranged inside thereof. The ball track and the spiral channel of the ball screw match each other and accommodate the plurality of balls therein. The rotation of the ball nut causes the plurality of balls to roll to achieve energy transfer and displacement conversion.

Therefore, the main purpose of the adjustable torque wrench improvement of the present invention is to provide a kind of utilization of ball screw as adjusting torque structure, through the characteristics of ball screw, so that the torque wrench will be more labor-saving, efficient and more durable when rotating and adjusting torque.

### BRIEF DESCRIPTION OF THE DRAWINGS

The present invention is further described below in conjunction with the accompanying drawings and embodiments.

FIG. 1 is a sectional view of a screw and a nut inside a conventional adjustable torque wrench.

FIG. 2 is a perspective view of an adjustable torque wrench improvement according to the present invention.

FIG. 3 is an exploded view of the adjustable torque wrench improvement according to the present invention.

FIG. 4 is an exploded view of the ball device of the adjustable torque wrench improvement according to the present invention.

FIG. 5 is a side sectional view of the ball device of the adjustable torque wrench improvement according to the present invention.

FIG. 6 is a sectional view of the ball device implemented in the adjustable torque wrench improvement of the present invention.

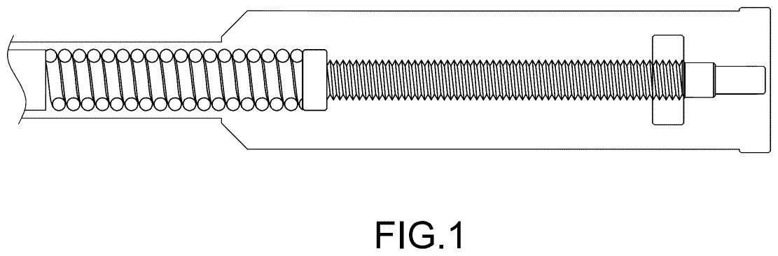

### DETAILED DESCRIPTION OF THE PREFERRED EMBODIMENT

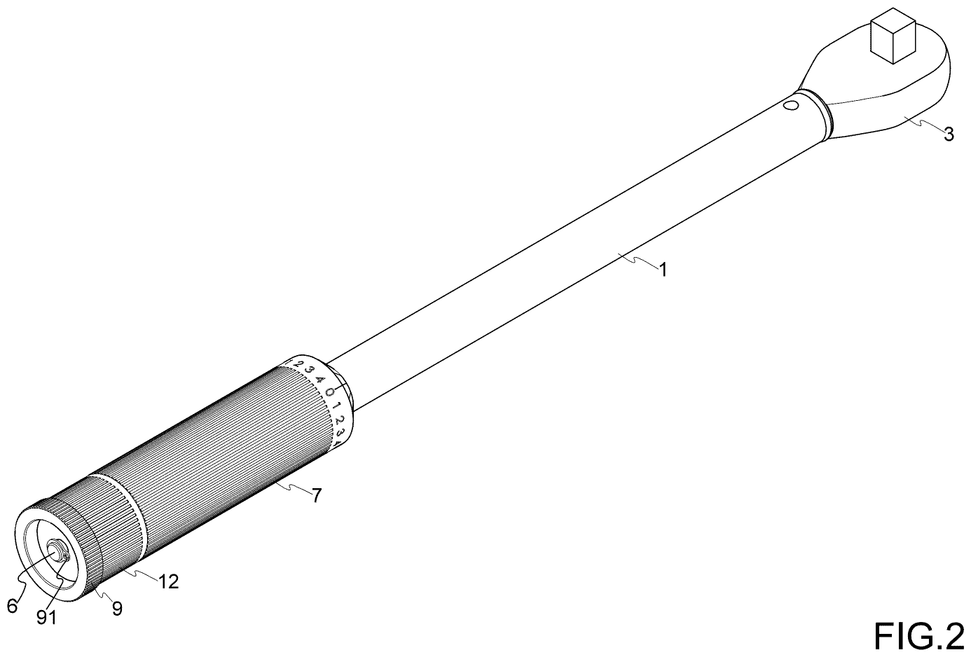

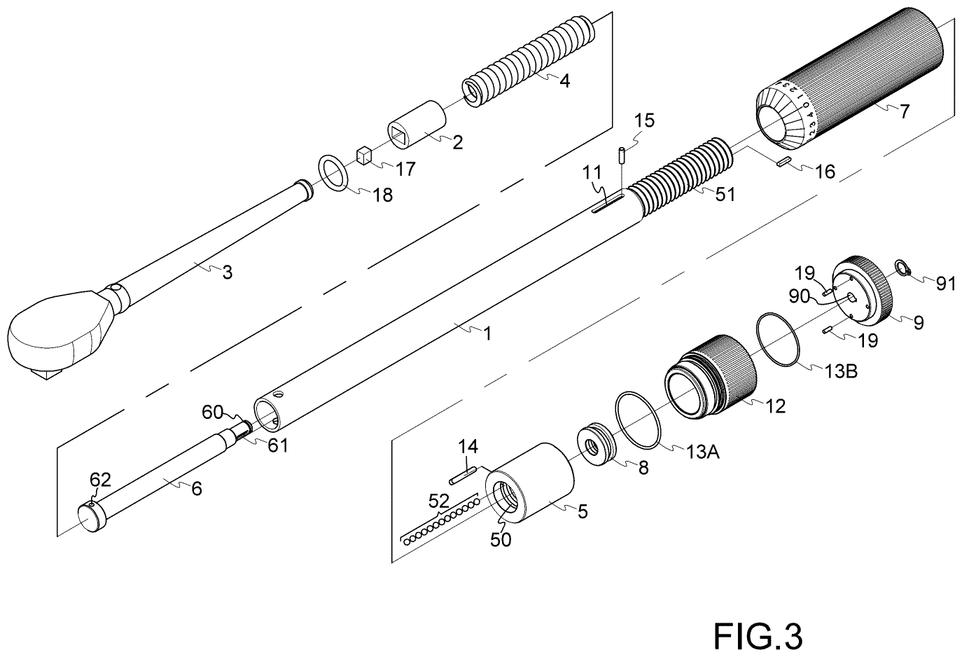

Firstly, referring to FIG. 2 and FIG. 3 simultaneously: the adjustable torque wrench improvement of the present invention includes a wrench head rod 3 sequentially provided with a first O-shaped ring 18, an ejector pin 17, an ejector pin seat 2, a pressure spring 4, and a push rod 6 accommodated in a torque rod 1, and the end of the torque rod 1 is sequentially provided with a ball screw 51, an A handle 7, a ball nut 5, a thrust bearing 8, a second O-shaped ring 13A, a B handle 12, a third O-shaped ring 13B, two first positioning pins 19, a C handle 9 and a C-shaped retaining ring 91.

The ball screw 51 is inserted through the ball nut 5, and both are accommodated in the A handle 7. The ball nut 5 has a first limiting key 14 provided on the outer ring thereof, which connects the A handle 7 with the ball nut 5 in unison, driving the ball screw 51 to rotate to adjust the torque value of the wrench.

The push rod 6 has a positioning hole 62 provided at a front end thereof for a second positioning pin 15 to pass therethrough. The second positioning pin 15 is fitted with the push rod 6 through a first limiting groove 11 of the torque rod 1 so that the first limiting groove 11 limits the linear axial reciprocating displacement path of both the second positioning pin 15 and the push rod 6 in the torque rod 1. In addition, the push rod 6 has a second limiting groove 61 provided at the side of the end, for receiving a second limiting key 16, to be inserted corresponding to the central through hole 90 of the C handle 9, and an embedded groove 60 is provided at the end of the push rod 6 for the C-shaped retaining ring 91 to be buckled, thereby assembling the integral torque wrench components.

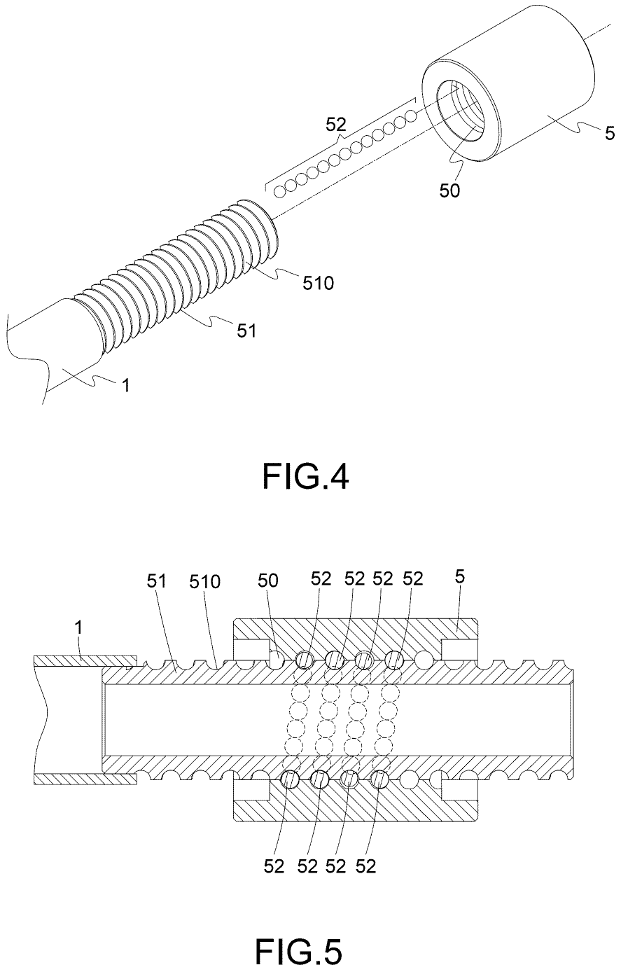

Referring to FIGS. 4 and 5 at the same time. The ball device of the present invention is arranged at the end of the wrench torque rod 1 and includes: a ball screw 51, a plurality of balls 52, and a ball nut 5. The ball screw 51 is a cylinder, and has a spiral channel 510 surrounding on the surface thereof for the displacement of the rotating movement. The ball nut 5 is a matching part with the ball screw 51. The ball nut 5 has a ball track 50 arranged inside thereof. The ball track 50 and the spiral channel 510 of the ball screw 51 match each other and accommodate the plurality of balls 52 therein. (As shown in FIG. 5, the plurality of balls 52 are shown in dotted lines.) The rotation of the ball nut 5 is used to make the balls 52 roll, so that the torque wrench can be more labor-saving and more efficient during rotation adjustment.

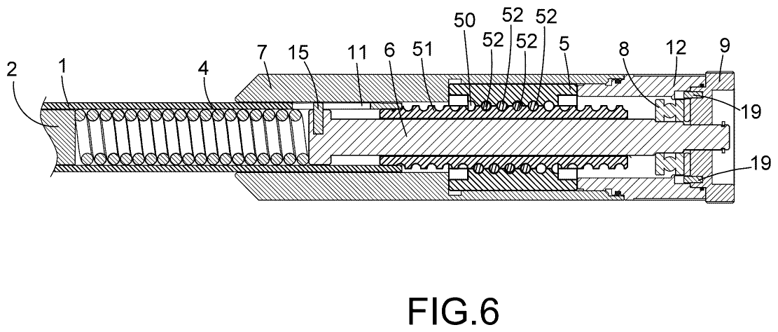

Referring to FIG. 6, which is a sectional view of the ball device of the present invention implemented in an adjustable torque wrench. The ball device includes the ball nut 5, the balls 52, and the ball screw 51, which are completely accommodated in the A handle 7, the B handle 12 and the C handle 9. The user only needs to rotate the A handle 7 to link the rolling of the ball nut 5 and the balls 52, and then drive the ball screw 51 to produce an axial displacement, drive the torque rod 1 to displacement simultaneously, and change the tension or relaxation of the pressure spring 4, thereby completing the adjustment of torque. Since the ball device uses the balls to reduce energy loss caused by friction, the wrench can save more effort and be more efficient when rotating to adjust the torque, allowing the user to adjust the required torque value more quickly and effortlessly.

The above descriptions are only preferred embodiments of the present invention and are not intended to limit the patentable scope of the present invention. All other equivalent changes or modifications made without departing from the spirit disclosed in the present invention shall be included in the following patent application scope.

What is claimed is:

1. An adjustable torque wrench improvement, comprising a ball device arranged thereon to adjust torque, wherein the ball device comprises a ball screw, a plurality of balls, and a ball nut arranged thereon respectively;
wherein the ball screw is arranged at the end of a wrench torque rod, is a cylinder, and has a spiral channel surrounding on the surface thereof for the ball nut and the balls to screw together;
wherein the ball nut has a ball track arranged inside thereof, and after being screwed with the ball screw, the plurality of balls are accommodated in the ball track;
wherein the rotation of the ball nut is used to cause the balls to roll, which drives an axial displacement of the ball screw, and at the same time drives the wrench torque rod to change the tightening or relaxation of the pressure spring, so as to complete the adjustment of the torque.
